(19) United States
(12) Patent Application Publication
(10) Pub. No.: US 2014/0318894 A1
(43) Pub. Date: Oct. 30, 2014

(54) Ladder support

(71) Applicant: James T. Chow, Toronto (CA)

(72) Inventor: James T. Chow, Toronto (CA)

(21) Appl. No.: 14/120,910

(22) Filed: Jul. 9, 2014

Related U.S. Application Data
(63) Continuation-in-part of application No. 13/815,366, filed on Feb. 26, 2013.

(30) Foreign Application Priority Data
Feb. 27, 2012 (CA) 2,769,963

(51) Int. Cl. E06C 7/48

(52) U.S. Cl. CPC E06C 7/48
USPC 182/214

(57) ABSTRACT

The support for a ladder has a frame which may be attached at various points on a ladder so that when the ladder is standing for use, the elevation of the frame is adjustable. The frame has an outer arm which extends parallel to the transverse axis of the ladder and outwardly from both of its sides. The arm is provided with two or more contacting surfaces which make contact with the stationary object which supports the ladder.

### CROSS REFERENCE TO RELATED PRIOR APPLICATIONS

This application is a Continuation-in-Part of application Ser. No. 13/815,366 filed on Feb. 26, 2013 now abandoned which application claims priority pursuant to 35 USC 119 of Canadian application no. 2,769,963 filed on Feb. 27, 2012, the entire contents of said U.S. application Ser. No. 13/815,366 and said Canadian application no. 2,769,963 are hereby incorporated into the following application by reference.

### FIELD OF THE INVENTION

This invention relates to a support for a ladder when standing for use and more particularly to a support which may be attached and detached from a ladder and which has provision for adjustment of its location in order to provide the best support for a ladder.

### BACKGROUND OF THE INVENTION

A ladder which is in a position for use must be firmly supported for reasons of safety. Very often there is no place where the ladder can be placed where it will give access to where it is required while ensuring that it is adequately supported. For example, if a ladder is required to give access to a window in an upper storey of a building, the window may be adjacent to the corner of the building, it may be adjacent to a downspout or it may be wider than the width of the ladder itself. In these situations, it may be impossible to place the ladder to safely reach the window.

If a ladder is required to give access to the soffit or fascia of a building or to a roof, the only support available is usually the gutter attached to the eaves of the building. Gutters are not intended for such use and rarely are strong enough to provide proper support for a ladder. Likewise, vinyl siding on a building is rarely strong enough to support a ladder and if a ladder is placed against it, the vinyl usually is dented by the weight of the ladder and becomes unsightly.

### SUMMARY OF THE INVENTION

I have invented a support for a ladder which can be placed where it will provide best support for the ladder. Briefly, the support of my invention includes a frame removably attachable to a ladder at preselected locations thereon such that when a ladder is standing for use, the elevation of the frame is adjustable. The frame is provided with contacting surfaces which are adapted to contact a stationary object for supporting the ladder.

### DESCRIPTION OF THE DRAWINGS

The ladder support of my invention is described with reference to the accompanying drawings:

FIGS. 1 and 2 are perspective views of the ladder support in conjunction with a conventional ladder;

FIG. 3 is a perspective view of a rung connector of the ladder support;

FIG. 4 is an elevation of the rung connector;

FIG. 5 is a perspective view of a link of the ladder support; and

FIGS. 6 and 7 are further perspective views of the ladder support.

Like reference characters refer to like parts throughout the description of the ladder support.

### DESCRIPTION OF PREFERRED EMBODIMENT

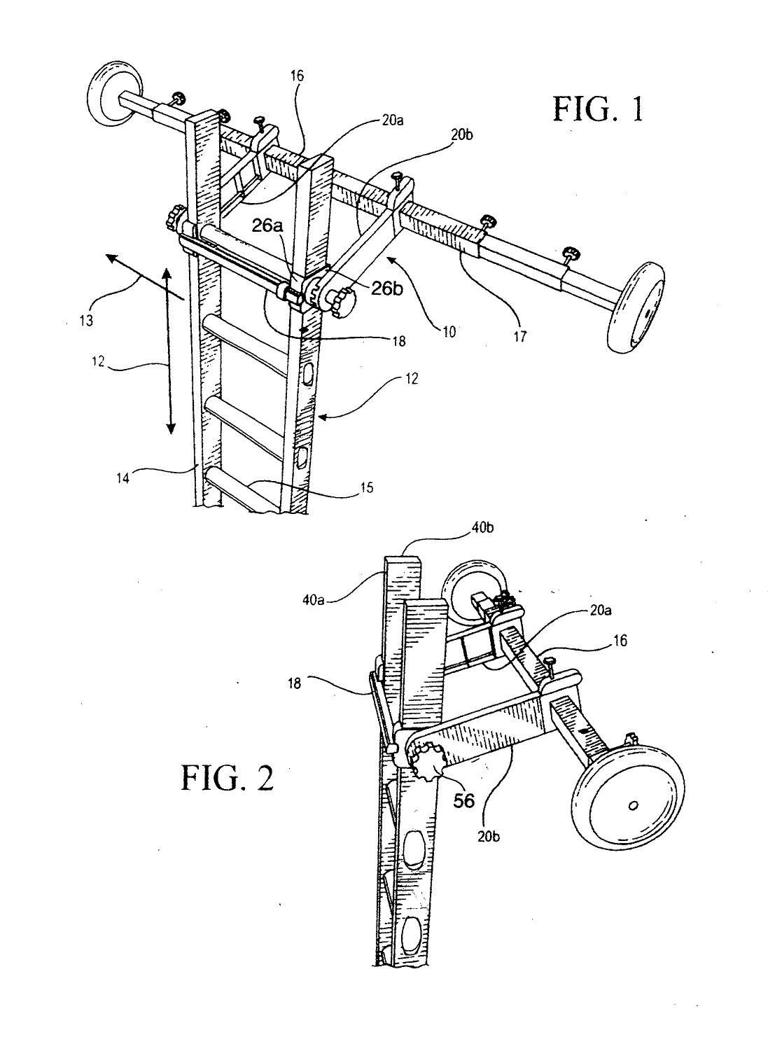

With reference to FIGS. 1 and 2, the ladder support of the invention, generally 10, is shown in conjunction with a conventional ladder, generally 12. The ladder has longitudinal and transverse axes 12,13 respectively. A pair of vertical supports 14 run parallel to the longitudinal axis and rungs 15 run parallel to the transverse axis.

The ladder support includes a frame, generally 16 having an outer arm 17, a rung connector, generally 18 and a pair of links 20a,b which interconnect the outer arm and the rung connector

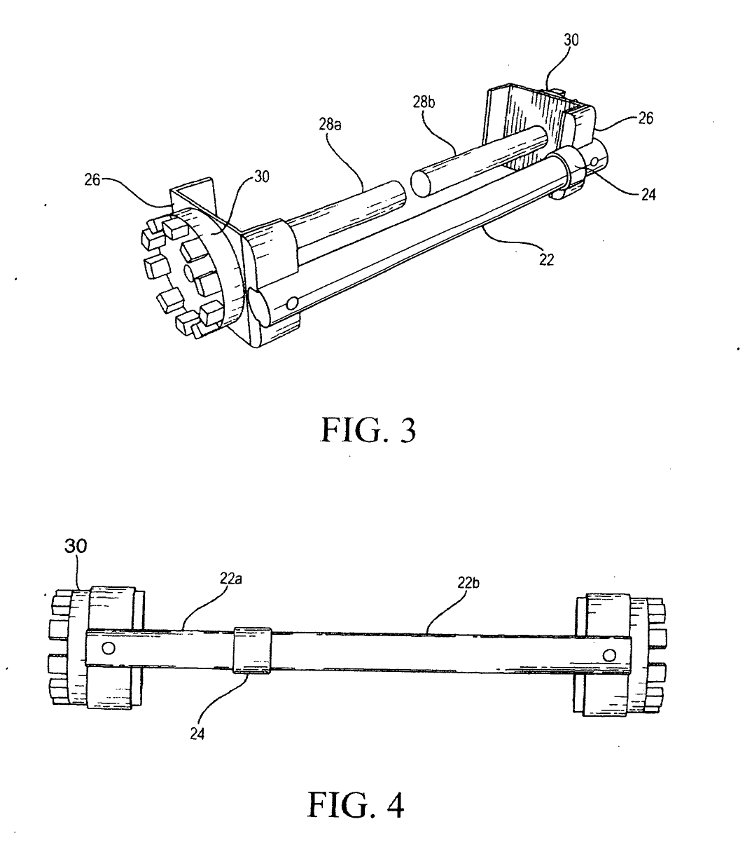

With reference to FIGS. 3 and 4, the rung connector 18 includes an outer tube 22 which is composed of a pair of sections 22a,b movable longitudinally of each other in telescopic relationship to define a variable effective length. A conventional locking ring 24 when tightened prevents the sections from moving relative to each other. The outer tube and locking ring function as clamping means for the rung connector as is explained below.

On each side of the rung connector is a U-shaped end wall 26 to which the outer ends of the outer tube are welded or otherwise attached. A rod 28 extends inwardly from each end wall. A sprocket 30 is welded or otherwise attached to the outer wall of each end wall. Its function is described below.

Preferably, the end walls 26 are constructed so that they can be fastened firmly to the vertical supports of a conventional ladder intended for industrial use. The vertical supports of the ladder are generally channels and the rungs are tubular. Such a ladder is illustrated in FIGS. 1 and 2. In those illustrations, flanges 26a extend inwardly from outer webs 26b of the end walls The rungs are spaced apart about 1 foot and the flanges 26a are spaced apart slightly more than 3 inches so that the end walls fit snugly over the vertical supports of the ladder. The segments of rod 28 are arranged so that they fit into the hollows of the rungs of the ladder when the end walls fit over the vertical supports of the ladder.

The end walls 26 are clamped or affixed to the rung of a ladder by means of outer tube 22. As the end walls of the rung connector are pushed toward each in order to fit them over separate vertical supports of the ladder, the two segments of the outer tube slide toward each other. When no further inward movement is possible, the segments are immobilized by means of locking ring 24. The end walls of the rung connector are then locked into engagement with the ladder.

The outer tube and locking pin accordingly function to clamp the rung connector to the ladder. Since the rod can be inserted into any of the rungs of the ladder, the elevation of the rung connector is adjustable. The ladder support is accordingly adjustable on the ladder at preselected locations i.e. wherever this is a rung.

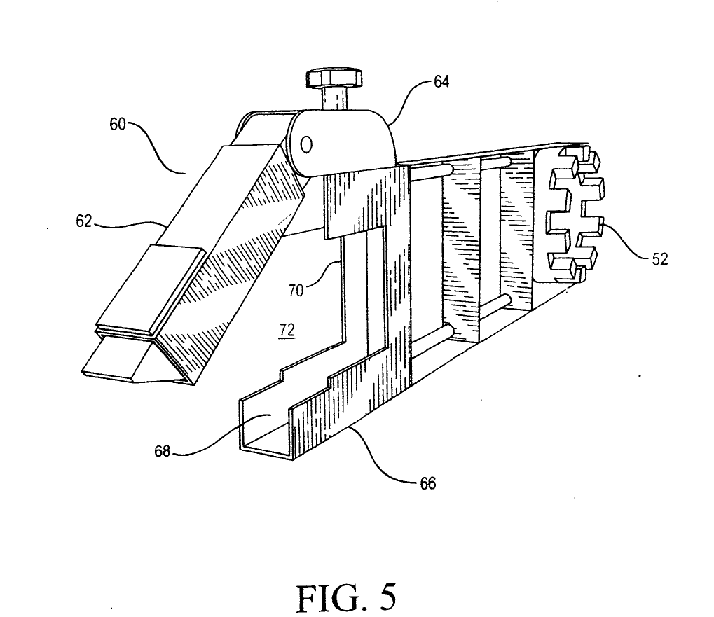

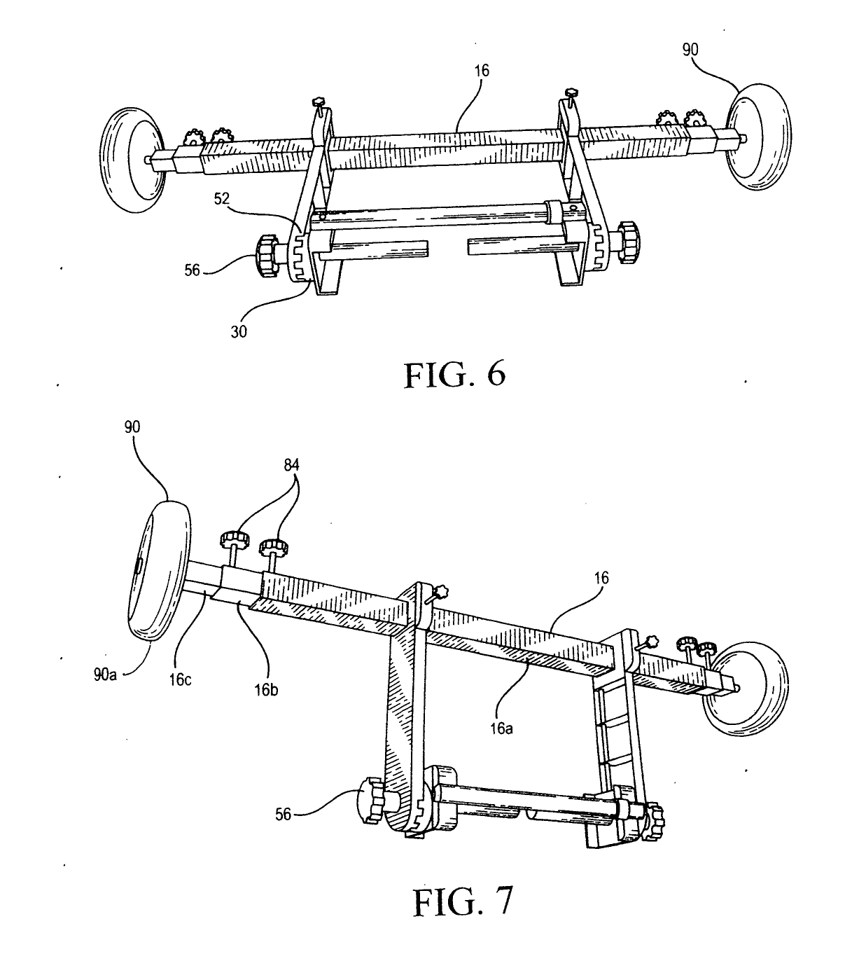

With reference to FIGS. 5, 6 and 7, each link 20 is composed of a channel 50 to which a sprocket 52 is welded or otherwise attached to its inner end. The latter sprocket is sometimes referred to below as the “outer sprocket” and its teeth fit into the spaces between the teeth of sprocket 30, sometimes referred to below as the “inner sprocket. The two sprockets are interconnected by a bolt (not illustrated) which extends through the end walls 26 of the rung connector, through the centre of the two sprockets 30, 52 and terminates at a threaded outer end to which a knurled knob 56 is threadably attached.

The two sprockets and the bolt constitute a coupling for interconnecting the ladder to the rung connector. The coupling is adjustable because loosening of knob 56 allows the links to be separated from the rung connector thereby allowing the outer sprocket on the link to be rotated relative to the inner sprocket with resulting alteration of the angle of the links relative to the ladder.

A fastener, generally 60, interconnects the outer ends of the links and the outer arm 16 of the frame. The fastener consists of an limb 62 having one end pivotally connected to a hollow mount 64 secured to the top wall of the link and the other end removably received in an upwardly opening trough 66. A removable pin 68 locks the limb in the trough

Fastener 60 and the end outer edge 70 of the channel define a rectangular opening generally 72 for receipt of a rectangular hollow central tube 16a of the outer arm. The edges which define the opening are straight and contact the flat outer walls of the outer arm. Rotation of the outer arm is accordingly prevented as the arm slides in the opening.

A pin 74 is vertically slidable relative to the fastener. The pin isposition to slide into and out of contact with the outer arm. When in contact with the outer end, the pin prevents the arm from sliding in opening 72.

Extending from each end of the central tube is a second rectangular tube 16b which has a smaller cross-section than the central tube and which, accordingly, is slidable in the hollow interior of the central tube. A third rectangular tube 16c fits into each end of second tubes. The tubes but may be immobilized by means of a number of thumb screws 84 spaced along the length of the arm. The effective length of the outer arm is accordingly variable because of the telescopic relationship of its components.

A wheel 90 is mounted for rotation to the outer end of each third tube 16c and rotates about transverse axis 13. Each wheel is horizontally spaced apart from the ladder and its circular outer wall 90a constitute a contacting surface which is adapted to contact a stationary object which supports the ladder. The stationary object will normally be the wall of a building but other objects may provide the necessary support. The wheels thus prevent the ladder from touching the wall or other stationary object when the ladder is standing for use.

By means of the thus-described ladder support, the position of wheels 90 can be positioned where they will provide best support for the ladder. The angle of links can be adjusted by means of sprockets 30, 52 thereby permitting vertical adjustment of the wheels while the telescopic structure of the outer arm 16 permits horizontal adjustment of the wheels.

It will be understood, of course, that modification can be made to the structure of the ladder support of the invention without departing from the scope and purview of the invention as defined in the appended claims.

I claim:

1. A ladder support for supporting a ladder when standing for use adjacent to a stationary object, said ladder having a pair of spaced apart vertical members and a plurality of hollow rungs each having a pair of oppositely facing ends connected to separate said vertical members, said ladder support including:
(i) a pair of end walls adapted to be disposed at opposite ends of any one of said hollow rungs, each said end wall being provided with a rod adapted to extend into opposite ends of said one rung;
(ii) an outer tube being disposed outside of said one rung and being composed of a pair of segments in telescopic relationship with each other, each said segment being movable in conjunction with a separate said end wall such that movement of said segments toward each other results in movement of said end walls toward each other into contact with the opposite facing walls of said one rung;
(iii) a locking means for immobilizing said segments relative to each other with resulting clamping of said end walls to said one rung;
(iv) an outer arm spaced apart from said one rung and oriented normal to said vertical members;
(v) a link which extends between each said end wall and said outer arm;
(vi) an adjustable coupling for selectively interconnecting each one of said links to each one of said end walls, said coupling being composed of a pair of inner and outer sprockets, said outer sprocket being attached to said one link and said inner sprocket being attached to said one end wall, each said sprocket positioned to mesh with the other said sprocket and to prevent said one link from pivoting relative to said one end wall when so meshed; and
(vii) adjusting means for tightening said inner and outer jaws sprockets together in order to cause said sprockets to mesh and for loosening said pair of sprockets so that said sprockets no longer mesh at which time said one link may pivot relative to said one end wall with resulting change in the elevation of said outer arm relative to said ladder.

2. The ladder support of claim 1 wherein said outer arm is slidable relative to said ladder, said outer arm being defined, in part, by a flat outer wall, said ladder support further including a fastener for interconnecting said link and said outer arm, said fastener having an opening in which said outer arm is slidingly accommodated, said opening being defined in part by a straight edge which contacts said flat outer wall of said outer arm, said straight edge functioning to prevent said outer arm from rotating within said opening.

3. The ladder support of claim 2 further including a pin slidable with respect to said fastener and selectively movable into and out of contact with said outer arm, said pin when in contact with said outer arm preventing said outer arm from sliding within said opening.

4. A ladder support of claim 1 further including a contacting surfaces provided on said outer arm, said contacting surfaces being adapted to contact said stationary object for supporting said ladder.

5. The ladder support of claim 4 wherein said outer arm frame is adapted to be spaced apart along its length from said stationary object save and except for said contacting surfaces,

6. The ladder support of claim 5 wherein said outer arm is adapted to extend along a transverse axis of said ladder which has both longitudinal and transverse axes, said vertical supports extending parallel to said longitudinal axis, said outer arm further being adapted to extend outwardly from opposite sides of said vertical supports, said pair of said contacting surfaces being located on opposite sides of said ladder.

7. The ladder support of claim 4 wherein said outer arm is telescopic such that its effective length is adjustable with resulting adjustability of the location of said contacting surfaces on said stationary object.

8. The ladder support of claim 4 wherein said contacting surfaces are composed of material which minimizes damage to said stationary object when in contact therewith.

9. The ladder support of claim 4 further including a pair of wheels mounted for rotation to said outer arm and each having a circular outer wall, each said contacting surface being defined by a separate said outer wall.

10. The ladder support of claim 6 further including a pair of wheels mounted for rotation to said outer arm and each having a circular outer wall, each said contacting surface being defined by a separate said outer wall, said wheels being rotatable about said transverse axis, as extended.
